(19) United States
(12) Patent Application Publication
(10) Pub. No.: US 2007/0281274 A1
(43) Pub. Date: Dec. 6, 2007

(54) Dental wrench and method of use thereof

(76) Inventors: Allan Schraffran, Toronto (CA); Andy Doug-Lun Wong, Toronto (CA); Robert G. Dickie, King City (CA)

Correspondence Address: SAND & SEBOLT, AEGIS TOWER, SUITE 1100, 4940 MUNSON STREET, NW, CANTON, OH, 44718-3615, US

(21) Appl. No.: 11/446,701

(22) Filed: Jun. 5, 2006

(51) Int. Cl. A61C 3/00; A61C 8/00

(52) U.S. Cl. 433/141; 433/174

(57) ABSTRACT

A dental instrument for installing and removing dental prostheses which includes both a speed wrench and a ratchet wrench, each being independently geared to a row of teeth on a screwdriver mounted in the dental instrument. The dental instrument includes a housing having a first and a second chamber. The screwdriver is partially mounted within the first chamber and the speed and rachet wrenches extend into the second chamber. The speed and ratchet wrenches are coaxially mounted within a handle that extends outwardly away from the housing. The speed wrench is rotatable about the longitudinal axis of the handle. The ratchet wrench is slidable along the longitudinal bore of the handle and is rotatable about the handle's longitudinal axis through 180°. The screwdriver is mounted in such a manner that the driver bit is oriented substantially at ninety degrees to the wrenches.

### BACKGROUND OF THE INVENTION

1. Technical Field

This invention generally relates to dental tools and instruments. More particularly, the invention relates to a dental instrument that is used for installing dental components relating to artificial teeth. Specifically, the invention relates to a universal dental wrench that includes a screwdriver and has both speed wrench and ratchet wrench capabilities.

2. Background Information

The advent of implant prosthodontics has brought about a paradigm shift in the way dentists secure artificial teeth in the oral cavity. In the early 1980's much of the fixed-detachable bridgework for full arch dental rehabilitation and restoration was attached by means of some type of retaining screw. Depending on the implant system used, the screws were torqued by hand to effect the clamping force necessary for retaining the implant in the jaw bone. Therefore, one of the early prosthetic complications was screw loosening that was caused by lack of initial pre-load of the screw, as well as poor fit and heavy bite forces.

As the industry moved forward in the early 1990's, single tooth and partially endentulous applications became commonplace. Torque wrenches were introduced with or without torque controllers. Screw loosening was significantly reduced by utilizing torque values anywhere from 15-35 Ncm and changing the screw composition from gold to alloyed materials. Two retention philosophies grew out of the new protocol, firstly, screw-retained fixed implant prostheses that may involve one or more abutment and retention screws and, secondly, cement-retained prostheses that usually have an abutment screw under one or more cemented crowns.

There are many competing implant systems currently available on the market for installing the retention and abutment screws and each has its own unique features. There are different size implants, abutments, abutment screws, thread orientations and screw-head driving types. Each manufacturer tends to produce their own types of screwdrivers and torque wrenches for installing and tightening these components. The wrenches and screwdrivers generally cannot be used for universal installation of these components. One of the more popular torque wrench systems on the market today is manufactured by Dentsply International, based in York, Pa. Dentsply International manufactures, amongst other products, both a torque screwdriver hub and a ratchet driver for loading dental components.

The steps to install and torque a retainer screw are typically as follows:

A cylindrical hole is drilled into the alveolar ridge of the patient and an implant bolt is inserted into that cylindrical hole. The implant bolt typically includes an external thread that allows it to bite into and grip the surrounding bone. The implant bolts generally also include an internally threaded bore that is adapted to receive a male portion of a prosthesis, i.e., an artificial tooth or a post for an artificial tooth. Once the implant bolt is installed in the jaw bone, it is covered and a period of time is allowed to pass so that the implant undergoes osseointegration, i.e., bone tissue infiltrates and surrounds the implant bolt to securely embed the same within the jaw bone. After this has occurred, the prosthesis is installed. This is accomplished as follows:
1. A screw is placed on the end of a small manual screwdriver. The screws are typically only about ¼ inch long and are therefore difficult to handle.

The prosthesis is inserted into position with respect to the implant bolt.

The screw is placed into the hole on the prosthesis and the dentist tries to hold the screw and prosthesis on the implant bolt with one finger and with the other hand tries to line up and begin to engage the threads on the screw.
2. Once the screw is started and there is no danger of dropping the screw and prosthesis, the dentist will use a speed wrench to turn the screw. A speed wrench is a 90° screwdriver with a rotary knob on its outer end that allows the dentist to turn the screw the required number of turns until it seats. It would seem obvious to try and use a small ratcheting-style wrench to tighten the screw, but for two issues. There is no room to swing the end of a ratcheting wrench in many areas of the mouth. Furthermore, the screw is so small and has so little resistance until it is properly seated that it would not allow the ratcheting wrench to properly ratchet the screw.
3. Once the screw has been seated with the speed wrench, the dentist will change his tool and will use a torque wrench to engage and properly tighten the screw according to the manufacturer's specifications.

The oral cavity is a relatively small space in which to work. Consequently, it is difficult and inconvenient for the dentist to have to keep switching tools, engaging miniaturized screws and then manipulating the tools in such a confined area.

There is therefore a need in the art for a dental implant instrument that enables a dentist to perform both a speed wrench type function and a ratchet wrench type function without having to change tools.

### SUMMARY OF THE INVENTION

The device of the present invention is a dental instrument that may be used to install and remove dental prostheses. The dental instrument includes both a speed wrench and a ratchet wrench, each being independently geared to a row of teeth on a screwdriver mounted in the dental instrument. The dental instrument includes a housing having a first and a second chamber which communicate with each other. The screwdriver is partially mounted within the first chamber and one end of each of the speed and rachet wrenches extends into the second chamber. The speed and ratchet wrenches are coaxially mounted within a handle that extends outwardly away from the housing. The speed wrench is rotatable in either direction about the longitudinal axis of the handle and, as it moves, it causes a corresponding rotation of the screwdriver. The ratchet wrench is slidable along the longitudinal bore of the handle to release it from engagement with the associated row of teeth on the screwdriver. The ratchet wrench is also rotatable about the handle's longitudinal axis through 180° once released, so as to correctly positioned to perform a ratcheting function, no matter which direction the screwdriver is rotated. The screwdriver is mounted in such a manner that the driver bit is oriented substantially at ninety degrees to the longitudinal axes of the wrenches.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of the universal dental wrench in accordance with the present invention;

FIG. 2 is an exploded perspective view of the dental wrench of FIG. 1;

FIG. 3 is a top view of the dental wrench;

FIG. 4 is a cross-sectional side view of the dental wrench;

FIG. 5 is a cross-sectional top view through line B-B of FIG. 4;

FIG. 6 is a bottom view of the dental wrench with the main body and outer handle removed; and

FIG. 7 is a side view of the dental wrench as shown in FIG. 6.

### DETAILED DESCRIPTION OF THE INVENTION

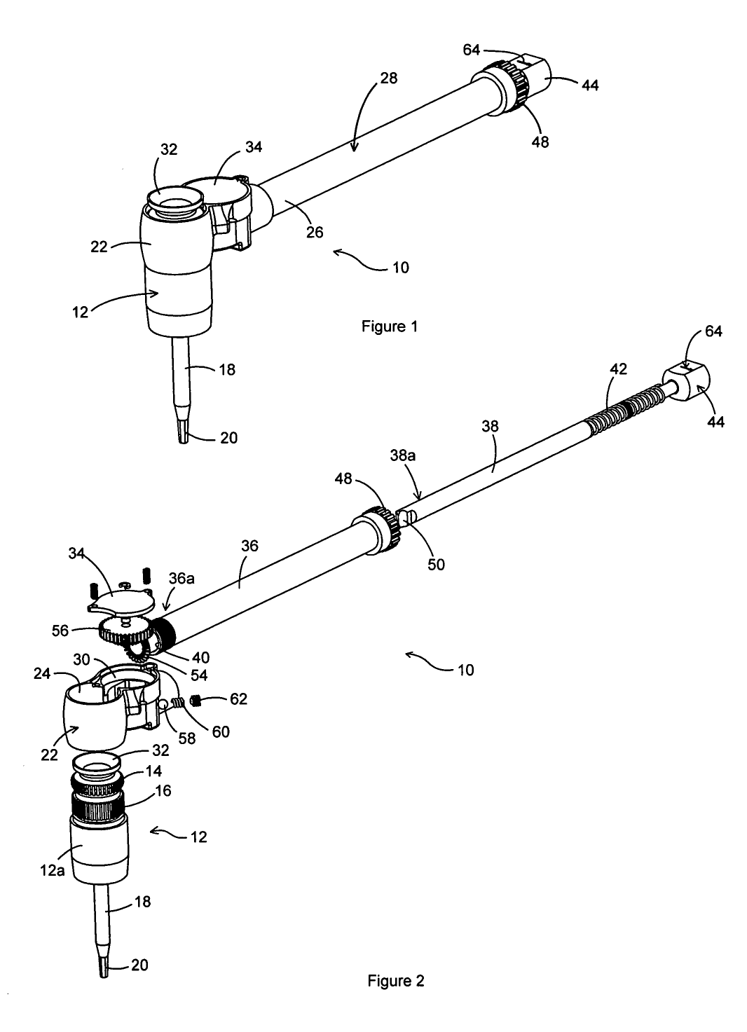

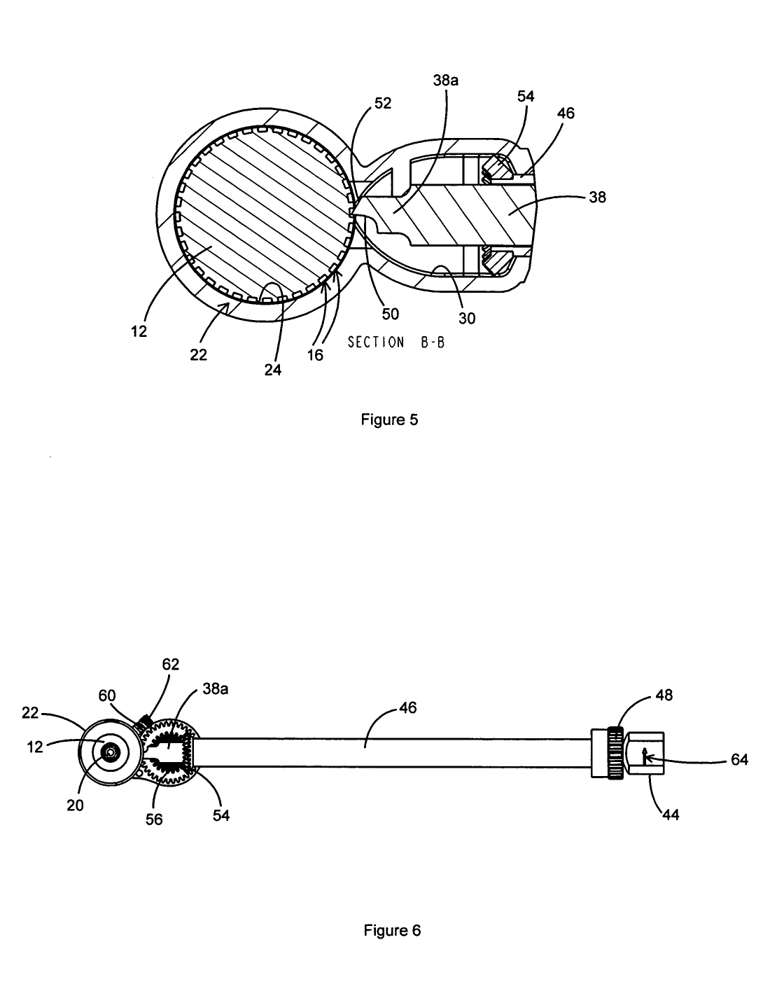

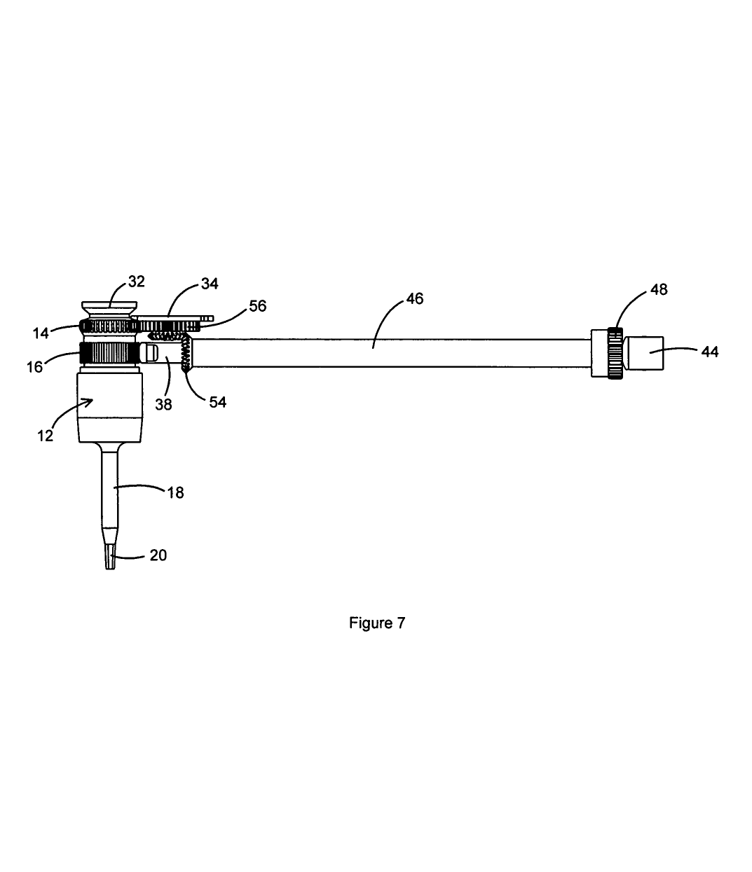

Referring to FIGS. 1-7, there is shown a universal dental implant wrench in accordance with the present invention and generally indicated at 10. Wrench 10 is a device that includes a dental screwdriver 12 in combination with a speed wrench and a ratchet wrench as will be hereinafter described.

Wrench 10 is designed to be used in conjunction with any suitable dental screwdriver known in the art. There are essentially two kinds of screwdrivers presently used in implant systems. Both screwdrivers look the same externally, but differ internally. The most common screwdriver is essentially a solid piece of stainless steel with knurling or teeth on its exterior surface to provide a grip when used by hand. These screwdrivers can also be used in conjunction with a dental ratchet which engages the teeth on the screwdriver. The second type of screwdriver is not a solid device and includes an internal slip clutch that slips when the correct torque setting is obtained. These torqued screwdrivers may also be used in conjunction with ratchet wrenches. One such suitable torque screwdriver is manufactured as part #45732 by Dentsply International. It is this torque screwdriver that is depicted as screwdriver 12 in the attached figures.

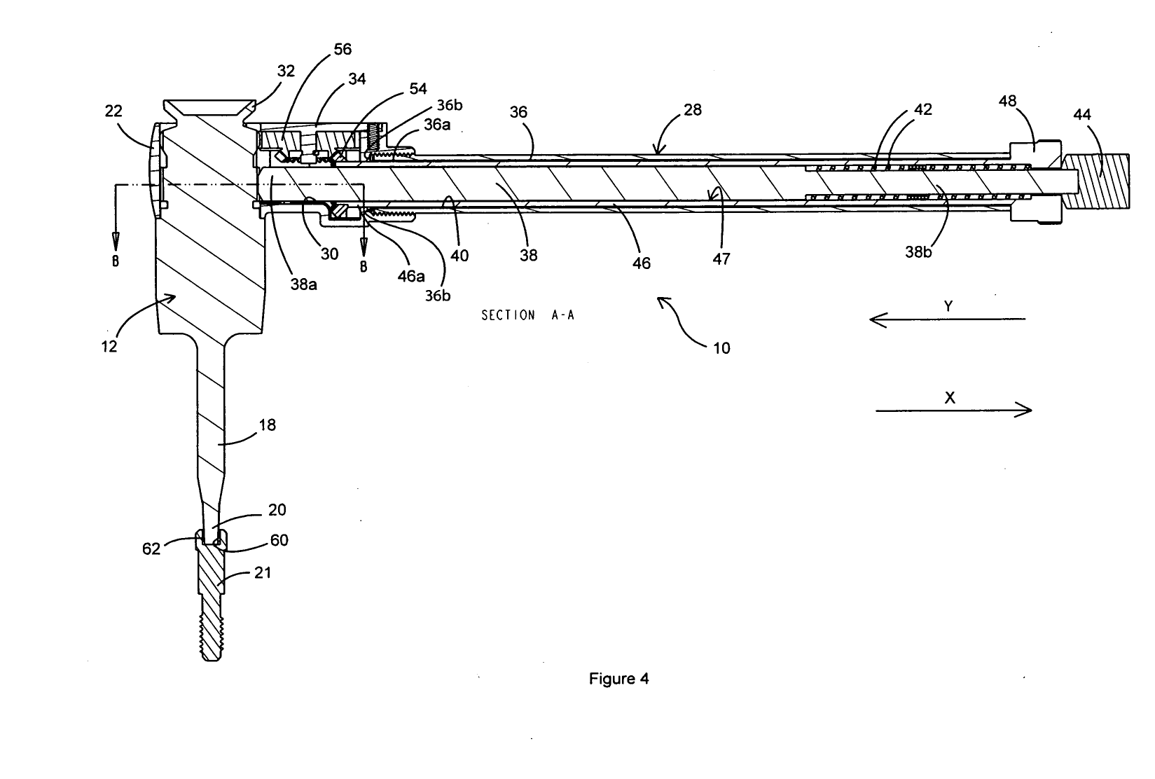

Referring to FIG. 2, screwdriver 12 has a body 12a that includes two rows of drive teeth thereon. The first row of drive teeth are speed wrench teeth 14 and the second row of teeth are ratchet drive teeth 16. Screwdriver 12 also includes an elongated shaft 18 and a driver bit 20 which are configured to engage a dental component such as a retainer screw 21 (FIG. 4).

In accordance with a specific feature of the present invention there is provided a housing 22 that receives an upper portion of screwdriver 12 in a first chamber 24 and a first end 26 of a handle 28 in a second chamber 30. First and second chambers 24, 30 are interconnected with each other. The upper portion of screwdriver body 12a disposed within first chamber 24 includes the rows of speed wrench teeth 14 and ratchet driver teeth 16. The top end 32 of screwdriver 12 protrudes out of first chamber 24 (FIG. 1). A cover 34 is screwed into position over second chamber 30 to protect the components retained therein.

Referring to FIG. 4, and in accordance with a specific feature of the present invention, handle 28 comprises an elongated cylindrical pipe 36 with a speed wrench 46 and ratchet wrench 38 concentrically received therein. A first end 36a of pipe 36 threadably engages housing 22 proximate second chamber 30. Handle 28 is a non-moving component that the dentist can hold to manipulate the instrument. A tubular speed wrench shaft 46 is disposed within the bore 40 of pipe 36. Shaft 46 extends into second chamber 30 of housing 22 and terminates inwardly from the threaded first end 36a of pipe 36. A bevel gear 54 is mounted on the inward end 46a of shaft 46. Shaft 46 extends through bore 40 and terminates slightly outwardly of second end 36b of pipe 36 in a speed wrench knob 48. Knob 48 is rotatable by hand and when knob 48 is so rotated, speed wrench shaft 46 rotates within bore 40 and thereby rotates bevel gear 54. The teeth on bevel gear 54 engage the teeth on an intermediate gear 56 that is disposed within second chamber 30 and is mounted substantially at right angles to bevel gear 54. Intermediate gear 56 engages the speed wrench teeth 14 on screwdriver 12.

A ratchet bar 38 is received through the bore 47 of speed wrench shaft 46 and extends into second chamber 30 of housing 22. A first end 38a of ratchet bar 38 is chisel-shaped (FIGS. 2 & 5) having first and second faces 50, 52 that are differently profiled. First face 50 is substantially arcuate and J-shaped, while second face 52 is substantially linear and angled. It should be understood, however, first and second faces 50, 52 can be shaped in a different manner without departing from the spirit of the present invention.

First end 38a of ratchet bar 38 is designed to engage ratchet drive teeth 16 on screwdriver 12. The second end 38b of ratchet bar 38 is of a reduced diameter and a coil spring 42 is disposed around this second end 38b. Coil spring 42 is compressed between the larger diameter portion of ratchet bar 38 and speed wrench knob 48 and urges first end 38a of ratchet bar 38 into engagement with ratchet drive teeth 16. A control knob 44 is provided on the second end 38b and this knob 44 enables the dentist to partially withdraw ratchet bar 38 from within the bore 40 of outer pipe 36 and to rotate ratchet bar 38 through 180°. When ratchet bar 38 is in a first position, first face 50 is presented for engagement with drive teeth 16. When ratchet bar 38 is rotated through 180°, then ratchet bar 38 presents a second face 52 for engagement with drive teeth 16.

Dental wrench 10 is also provided with a ball bearing 58 and an associated spring 60 and screw 62 which urges the ball bearing 58 between speed wrench teeth 14 and ratchet drive teeth 16.

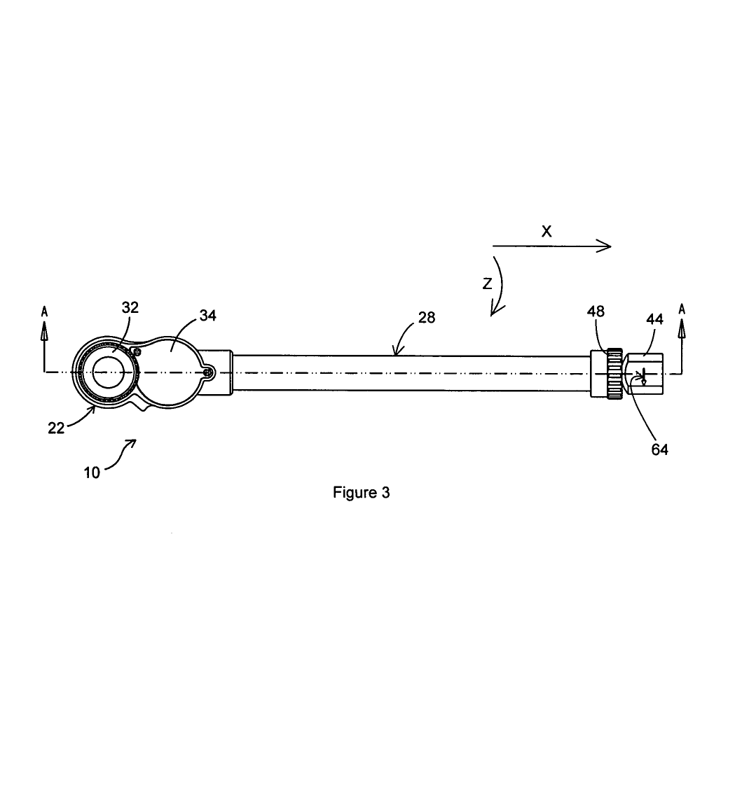

The dental wrench 10 is used in the following manner. The dentist positions the retainer screw 21 on the prosthesis (not shown), and starts the threads by hand with a manual screwdriver (not shown). Once the threads have taken sufficiently, wrench 10 is engaged with screw 21 by inserting driver tip 20 into a recess 60 in the head 62 of screw 21. The dentist then sets ratchet bar 38 for clockwise movement of speed wrench shaft 46. The dentist can tell if the ratchet bar 38 is oriented correctly by observing the arrow marker 64 (FIG. 1) on control knob 44. If the dentist determines that the ratchet bar 38 is not oriented correctly, he will pull knob 44 outwardly in the direction of arrow “X” (FIGS. 3 & 4). This slides ratchet bar 38 part-way through bore 47 of speed wrench shaft 46, and compresses coil spring 42 against control knob 48. Ratchet bar 38 is then rotated through 180° by turning knob 44 in either a clockwise or anticlockwise direction. Then knob 44 is released when the marker 64 faces in the opposite direction. This allows the compressed coil spring 42 to revert to its original size and position, thereby forcing ratchet bar 38 to slide along bore 47 in the direction of arrow “Y” (FIG. 4). First end 38a of ratchet bar 38 is thereby forced back into engagement with ratchet driver teeth 16. When ratchet bar 38 is set for speed wrench shaft 46 to rotate in a clockwise direction, then first face 50 of ratchet bar 38 is presented for engagement driver teeth 16. The dentist turns the speed wrench knob 48 in a clockwise direction the number of turns needed to seat screw 21. The rotation of speed wrench knob 48 and thereby speed wrench shaft 46 drives bevel gear 54 which in turn drives intermediate gear 56. The teeth of intermediate gear 46 engage speed wrench teeth 14 causing screwdriver 12 to rotate in a first direction. The screwdriver 12 will rotate in one direction only and as it does so, ratchet bar 38 will ratchet the screw during this process. The dentist will turn speed wrench knob 46 the required number of turns to finger tighten screw 21. Once screw 21 is finger-tightened, the dentist will move handle 28 in a small arc in the direction of arrow “Z” (FIG. 3) to torque screw 21 to the manufacturer's recommended specifications. Since screwdriver 12 is a torque screwdriver, it is pre-calibrated and will therefore slip when the correct preset torque limit is attained.

If the dentist wishes to remove a prosthesis, the direction of rotation of screwdriver 12 and the ratcheting of rachet bar 38 can be reversed to unscrew screw 21. This is achieved by pulling control knob 44 outwardly in the direction of arrow “X”, rotating ratchet bar 38 in the opposite direction, as indicated by arrow marker 64, releasing knob 44 and then rotating speed wrench knob 48 in an anticlockwise direction. Rotation of ratchet bar 38 through 180° brings face 52 into engagement with ratchet drive teeth 16. Rotating speed wrench shaft 46, by turning speed wrench knob 48 in the opposite direction, causes bevel gear 54 and therefore intermediate gear to rotate in the opposite direction. Consequently, screwdriver 12 rotates in the opposite direction and unscrews the screw 21.

Dental wrench 10 therefore provides a bidirectional ratcheting function and a bidirectional speed wrench function in the same device. Both the ratchet bar 38 and speed wrench shaft 46 are disposed at approximately 90° to the directions in which the screw 21 is being inserted or withdrawn. Consequently, the dentist does not have to work within the limited confines of the patient's mouth, but can perform both the screwing and ratcheting functions in a more easily accessible location.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A dental instrument for use in installing prostheses; said instrument comprising:
a housing adapted to retain a screwdriver that includes a plurality of drive teeth and a driver bit;
a speed wrench connected to the housing and adapted to operationally engage the plurality of drive teeth on the screwdriver when activated; and
a ratchet wrench connected to the housing and adapted to operationally engage the plurality of drive teeth on the screwdriver when activated: and wherein said speed wrench has a first path of operation and said ratchet wrench has a second path of operation different from the first path of operation.

2. The dental instrument as defined in claim 1, wherein housing includes a handle extending outwardly away therefrom and the the speed wrench is selectively rotatable about a longitudinal axis of the handle in one of two opposing directions; whereby rotation of the speed wrench in a first direction causes the screwdriver to rotate about the screwdriver's longitudinal axis in a one clockwise and counterclockwise direction and screw in the prosthesis, and rotation of the speed wrench in a second direction causes the screwdriver to rotate about the screwdriver's longitudinal axis in the other of a clockwise and counterclockwise direction and unscrew the prosthesis.

3. The dental instrument as defined in claim 1, wherein the ratchet wrench is selectively operable in one of two opposing directions.

4. The dental instrument as defined in claim 1, wherein the housing has a first and a second chamber; and the first chamber is adapted to retain a portion of the screwdriver that includes the plurality of drive teeth thereon.

5. The dental instrument as defined in claim 4, wherein the first and second chambers are in communication with one another; and at least a first end of the speed wrench is received within the second chamber in the housing and operationally engages the plurality of teeth on the portion of the screwdriver disposed in the first chamber.

6. The dental instrument as defined in claim 4, wherein the first and second chambers are in communication with each other; and at least a first end of the ratchet is received within the second chamber and operationally engages the plurality of teeth on the portion of the screwdriver disposed in the first chamber.

7. A dental instrument for use in installing prostheses: said instrument comprising:
a housing adapted to retain a screwdriver that includes a plurality of drive teeth and a driver bit:
a speed wrench connected to the housing and adaDted to oDerationally engage the plurality of drive teeth on the screwdriver when activated:
a cylindrical handle fixedly connected to and extending outwardly away from the housing; and wherein the speed wrench comprises a tubular member which is coaxially received through a longitudinal bore of the handle; and
a ratchet connected to the housing and adapted to operationally engage the plurality of drive teeth on the screwdriver when activated.

8. The dental instrument as defined in claim 7, wherein the speed wrench is rotatable within the bore of the handle and about the longitudinal axis thereof.

9. The dental instrument as defined in claim 8, wherein the tubular member of the speed wrench extends outwardly beyond the handle and terminates in an annular knob; and wherein the knob is operable to effect rotation of the tubular member within the bore of the handle.

10. The dental instrument as defined in claim 9, further comprising:
a bevel gear mounted on the first end of the speed wrench;
an intermediate gear mounted on the housing and being oriented to operationally engage both the bevel gear and the plurality of teeth on the screwdriver; whereby the bevel gear operationally drives the screwdriver in response to rotation of the speed wrench.

11. The dental instrument as defined in claim 10, wherein the intermediate gear is adapted to engage a first row of teeth on the screwdriver and the ratchet wrench is adapted to engage a second row of teeth on the screwdriver.

12. The dental instrument as defined in claim 8, wherein the ratchet wrench is coaxially received through a longitudinal bore of the tubular member.

13. The dental instrument as defined in claim 12, further comprising a spring disposed between a portion of the ratchet wrench and a portion of the speed wrench, wherein said spring urges a first end of the ratchet wrench into the second chamber of the housing.

14. The dental instrument as defined in claim 13, wherein the ratchet wrench is configured for sliding and rotational movement within the bore of the tubular member.

15. The dental instrument as defined in claim 14, wherein the first end of the ratchet wrench has a first face and a second face that are differently profiled from each other said first face being substantially planar and said second face being substantially arcuate.

16. The dental instrument as defined in claim 15, wherein the ratchet wrench is selectively rotatable through 180° to bring one of the first and second faces into engagement with the teeth of the second row.

17. A dental instrument for installing and removing dental prostheses; comprising a speed wrench and a ratchet wrench that both form part of a handle of the dental instrument and are independently geared to at least one plurality of teeth on a screwdriver mounted in the dental instrument; wherein the speed wrench is activated by rotating a portion of the handle about a longitudinal axis thereof: and the ratchet wrench is activated by rotating the handle about a longitudinal axis of the screwdriver: and wherein the screwdriver includes a driver bit that is oriented substantially at ninety degrees to both the speed wrench and the ratchet wrench; and wherein said driver bit is adapted to engage a recess on the dental prosthesis and to selectively rotate the prosthesis in one of a first and second direction.

18. A method of installing and removing a dental prosthesis comprising the steps of:
engaging a screwdriver having a driver bit to a rachet assembly;
engaging the driver bit with a prosthesis screw to be installed in the oral cavity of a patient;
engaging a speed wrench of the ratchet assembly to rotate the screw in one of a first direction and a second direction;
engaging a ratchet wrench of the ratchet assembly to rachet the screw in the one of the first and second directions.

19. The method as defined in claim 18, wherein the step of engaging the ratchet wrench further comprises the step of:
rotating the ratchet wrench to present one of a first face and a second face for engagement with a plurality of teeth disposed on the screwdriver.

20. The method as defined in claim 19, wherein the step of rotating the ratchet wrench includes the step of:
sliding the ratchet wrench in a first direction longitudinally outwardly through a bore in the speed wrench to disengage one of the first and second faces from the teeth on the screwdriver;
rotating the ratchet wrench through 180°;
sliding the ratchet wrench in a second direction longitudinally inwardly through the bore of the speed wrench to engage the other of the first and second faces with the teeth on the screwdriver.

21. A dental instrument for use in installing prostheses; said instrument comprising:
a housing;
a handle extending outwardly away from the housing; said handle having a longitudinal axis;
a screwdriver retained within the housing and having a longitudinal axis disposed at right angles to the longitudinal axis of the handle; said screwdriver including a plurality of drive teeth and a driver bit;
a speed wrench forming part of the handle and being rotatable about the longitudinal axis of the handle; said speed wrench being operationally engaged with the plurality of drive teeth to selectively rotate the screwdriver about the screwdriver's longitudinal axis when the speed wrench is rotated about the handle's longitudinal axis; and
a ratchet wrench forming part of the handle and being operationally engaged with the plurality of drive teeth to selectively rotate the screwdriver about the screwdriver's longitudinal axis when the handle is rotated about the screwdriver's longitudinal axis
